(19) United States
(12) Patent Application Publication
(10) Pub. No.: US 2025/0028491 A1
(43) Pub. Date: Jan. 23, 2025

(54) PRODUCT SALES DATA PROCESSING DEVICE AND METHOD

(71) Applicant: TOSHIBA TEC KABUSHIKI KAISHA, Tokyo (JP)

(72) Inventors: Sayo Sonaga, Kawasaki Kanagawa (JP); Maki Sato, Yokohama Kanagawa (JP); Yumiko Okuma, Koganei Tokyo (JP)

(21) Appl. No.: 18/627,469

(22) Filed: Apr. 5, 2024

(30) Foreign Application Priority Data
Jul. 19, 2023 (JP) 2023-117822

(51) Int. Cl. G06F 3/14; G07G 1/00

(52) U.S. Cl. CPC G06F 3/14; G07G 1/0009; G07G 1/0072

(57) ABSTRACT

According to one embodiment, a product sales data processing device includes a first acquisition unit configured to acquire identification information that can specify a product, a registration unit configured to register the product based on the identification information, and a display unit configured to arrange and display, on a same screen, information on products registered by the registration unit in the order of registration, and display an operator for instructing an end of registration, in which the display unit periodically changes a display mode of the operator using a moving animation so as to perform highlighting.

### CROSS-REFERENCE TO RELATED APPLICATION

This application is based upon and claims the benefit of priority from Japanese Patent Application No. 2023-117822, filed on Jul. 19, 2023, the entire contents of which are incorporated herein by reference.

### FIELD

Embodiments described herein relate generally to a product sales data processing device and a method.

### BACKGROUND

In the related art, stores such as supermarkets and convenience stores are provided with Point of Sales (POS) terminals for registering and checking out products purchased by customers. Additionally, in recent years, self-checkout POS terminals are also available, with which customers themselves perform operations related to the product registration and checkouts. When products are registered, these POS terminals display a screen (hereinafter also referred to as a product registration screen), displaying a list of registered products together with various operators related to the operation of the device.

Meanwhile, with the POS terminals described above, when the registration of products is complete, an operator performs an operation (hereinafter also referred to as a closing operation) for instructing the end of registration or the start of checkout based on the operators displayed on the screen. The POS terminal receiving the closing operation can perform a checkout process based on the total amount of the products registered so far.

Meanwhile, on the product registration screen, because information on the registered products is additionally displayed each time registration is performed, a relatively large amount of information is displayed, and the operator's gaze tends to stay at the registered product. Therefore, there is a problem in that it is difficult for the operator to find the position of the operator for performing the closing operation. If the operator for performing the closing operation is difficult to find, the customers particularly who are not familiar with operating the POS terminals may not be able to proceed to checkout for the product even after completing registering the products, which may hinder smooth transactions.

In addition, in the related art, technology has been proposed that prompts users to perform operations by displaying blinking operators on a static screen such as an amount-of-change display screen, but applying this method to a dynamic product registration screen that updates the displayed information each time a product is registered does not guarantee that the operators are effectively highlighted, and there is room for improvement in terms of operability.

### DESCRIPTION OF THE DRAWINGS

FIG. 1 is a front view showing an example of an external appearance of a self-POS terminal according to a first embodiment;

FIG. 2 is a diagram showing an example of a hardware configuration of the self-POS terminal;

FIG. 3 is a diagram showing an example of a data structure of a product master;

FIG. 4 is a diagram showing an example of a functional configuration of the self-POS terminal;

FIG. 5 is a diagram showing an example of a screen displayed on the self-POS terminal of the first embodiment;

FIG. 6 is a diagram provided to explain a first highlighting method;

FIG. 7 is a diagram provided to explain a second highlighting method;

FIG. 8 is a diagram provided to explain a third highlighting method;

FIG. 9 is a diagram provided to explain a fourth highlighting method;

FIG. 10 is a diagram provided to explain a fifth highlighting method;

FIG. 11 is a diagram provided to explain a sixth highlighting method;

FIG. 12 is a flowchart showing an example of processing product sales data by the self-POS terminal of the first embodiment;

FIG. 13 is a front view showing an example of the external appearance of a self-POS terminal according to a second embodiment;

FIG. 14 is a diagram showing an example of the hardware configuration of a self-POS terminal;

FIG. 15 is a diagram showing an example of the functional configuration of the self-POS terminal;

FIG. 16 is a diagram showing an example of a display format of a product registration screen according to a first modification; and

FIG. 17 is a diagram provided to explain a modification of the third highlighting method.

### DETAILED DESCRIPTION

An aspect to be solved by an exemplary embodiment is to provide a product sales data processing device and a method capable of improving operability.

In general, according to one embodiment, a product sales data processing device includes a first acquisition means for acquiring identification n information that can specify a product, a registration means for registering the product based on the identification information, and a display means for arranging and displaying, on a same screen, information on products registered by the registration means in the order of registration, and displaying an operator for instructing an end of registration, in which the display means periodically changes a display mode of the operator using a moving animation so as to perform highlighting.

Hereinafter, embodiments will be described in detail with reference to the drawings. In the embodiment, a self-checkout POS terminal (hereinafter also referred to as self-POS) will be described as an example of a product sales data processing device. It is to be noted that an exemplary embodiment is not limited to the embodiments described below.

### First Embodiment

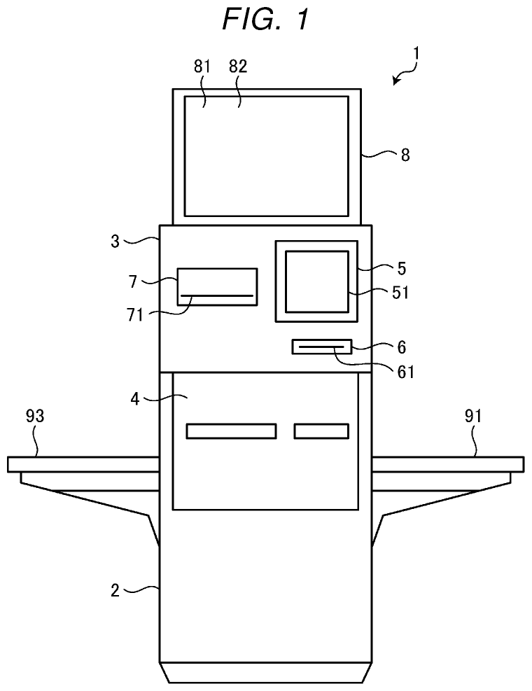

FIG. 1 is a front view showing an example of an external appearance of a self-POS terminal 1 according to the first embodiment. As shown in FIG. 1, the self-POS terminal 1 is of a vertically elongated and substantially rectangular parallelepiped shape, for example, and includes a first housing 2 and a second housing 3. The first housing 2 is positioned on a lower side of the substantially rectangular parallelepiped shape, and includes therein a cash storing and dispensing unit 4. The cash storing and dispensing unit 4 receives cash payment from a customer and dispenses corresponding changes to the customer under the control of a control unit 100 described below.

The second housing 3 is positioned on an upper side of the substantially rectangular parallelepiped shape, and includes the control unit 100 therein, which will be described below. Further, the second housing 3 includes, as interfaces operated by the user, a code reading unit 5, a card reading unit 6, and a printing unit 7.

The code reading unit 5 is a reading device that reads information held in code symbols such as barcodes, two-dimensional codes, and the like. The code reading unit 5 reads the code symbols through a reading window 51 formed in the second housing 3. For example, the code reading unit 5 reads a code symbol attached to a product or a code symbol displayed on a user's terminal or the like.

The card reading unit 6 is a reading device that reads information held in a card-type medium. The card reading unit 6 reads information from a card medium inserted into a card insertion slot 61. For example, the card reading unit 6 reads information related to electronic payment from a credit card or an electronic money card.

The printing unit 7 is a printing device such as a thermal printer. The printing unit 7 prints a receipt for the product purchased by the user, and outputs (dispenses) the printed receipt from a receipt issuing port 71 formed in the second housing 3.

Further, the self-POS terminal 1 includes a display operation unit 8. The display operation unit 8 is provided on a top surface of the second housing 3, for example. The display operation unit 8 includes a display unit 81 including a display device such as a Liquid Crystal Display (LCD), and an operation unit 82 including a touch panel or the like. The display unit 81 displays various information and images under the control of the control unit 100 which will be described below. The operation unit 82 is provided on a surface of the display unit 81 and outputs information based on a position of touch by the user to the control unit 100.

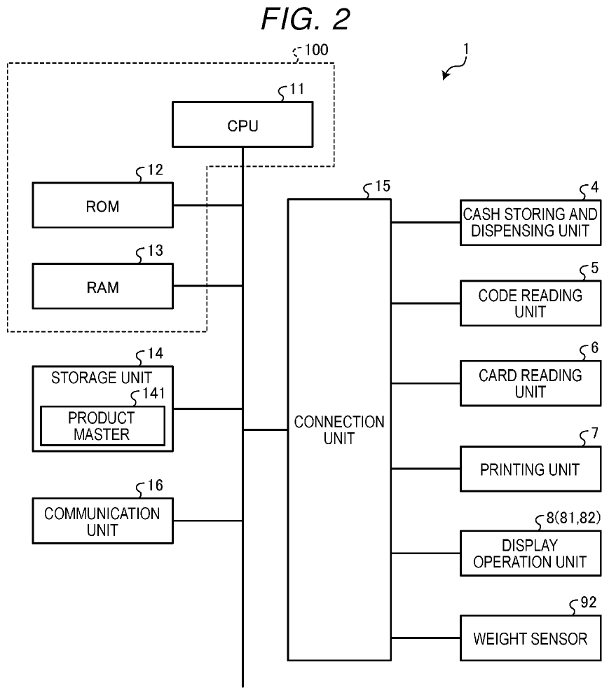

Further, a first placing table 91 is provided on one side of, or on a side of the self-POS terminal 1. The first placing table 91 is an example of a placing unit. The first placing table 91 is a table to place a product for registration, and is used when placing a basket containing products, for example. The first placing table 91 is provided with a weight sensor 92 (see FIG. 2) such as a weight scale. The weight sensor 92 measures the weight of an object placed on the first placing table 91.

Further, a second placing table 93 is provided on the other side of, or on a side of the self-POS terminal 1. The second placing table 93 is used when placing a storage bag such as a my bag for placing a product of which code symbol is read by the code reading unit 5, for example.

It is to be noted that the configuration of the self-POS terminal 1 is not limited to that shown in FIG. 1. For example, the second placing table 93 may include a weight sensor similar to the weight sensor 92.

FIG. 2 is a diagram showing an example of a hardware configuration of the self-POS terminal 1 according to the first embodiment. As shown in FIG. 2, the self-POS terminal 1 includes, among others, the cash storing and dispensing unit 4, the code reading unit 5, the card reading unit 6, the printing unit 7, the display unit 81, and the operation unit 82, which are described above.

In addition, the self-POS terminal 1 includes a Central Processing Unit (CPU) 11, which is an example of a processor, a Read Only Memory (ROM) 12, a Random Access Memory (RAM) 13, a storage unit 14, a connection unit 15, a communication unit 16, and the like. The CPU 11 is connected to each of the hardware configurations shown in FIG. 2 via a bus or the like.

The CPU 11 includes one or a plurality of processing circuits, and collectively controls each part of the self-POS terminal 1. The ROM 12 stores various programs. The RAM 13 is a workspace for loading programs and various kinds of data. The CPU 11, the ROM 12, and the RAM 13 form the control unit 100 which is an example of a computer.

The storage unit 14 has a storage medium such as a Hard Disk Drive (HDD) or a flash memory, and maintains the stored contents even if the power is cut off. The storage unit 14 stores various programs that can be executed by the CPU 11, setting information, and the like. Further, the storage unit 14 stores a product master 141 and various data related to display of a user interface (UI), which will be described below.

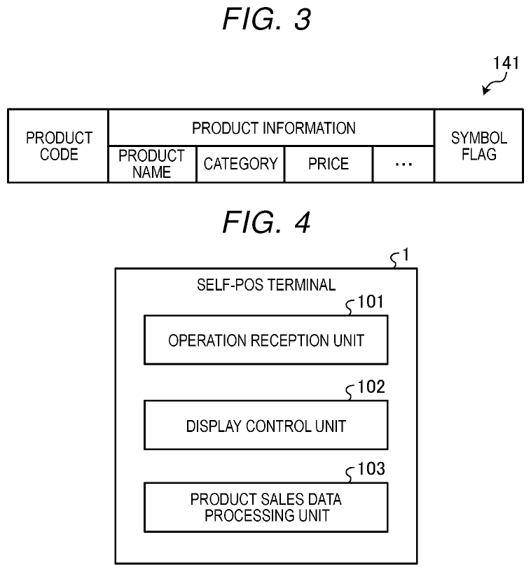

The product master 141 is a data table or database that stores information on products on sale. FIG. 3 is a diagram showing an example of a data structure of the product master 141 according to the first embodiment. As shown in FIG. 3, the product master 141 stores product information and symbol flags for a product specified by the product code in association with the product code of each product.

The product code is an example of identification information, and for example, product identification information such as a JAN code may be used. Each product sold at a store is attached with a code symbol such as a barcode or two-dimensional code that indicates the product code of the product. Furthermore, by reading the product code from the code symbol attached to the product, the product may be specified.

The product information includes information such as product name, category, price (unit price), and the like. The category is information indicating a classification of the product that includes the product corresponding to the product code. For example, classification names such as vegetables, fruits, seafood, etc. are registered in the category.

The symbol flag is flag information that can identify whether or not a code symbol is attached to the product. Further, the symbol flag may be provided in such a form that is added to a product to which no code symbol is attached. Examples of the product to which no code symbol is attached include fruits and vegetables.

It is to be noted that the data structure of the product master 141 is not limited to the example shown in FIG. 3. For example, the product master 141 may store image data representing the product, weight, etc., by including the same in the product information.

Referring back to FIG. 2, the connection unit 15 is an I/O interface for connecting the control unit 100 to each device provided in the self-POS terminal 1. The control unit 100 is connected to the cash storing and dispensing unit 4, the code reading unit 5, the card reading unit 6, the printing unit 7, the display operation unit 8, the weight sensor 92, etc. via the connection unit 15.

The communication unit 16 is a communication interface that can be connected to a network such as a Local Area Network (LAN) not shown. The communication unit 16 is in communication with an external device such as a store server provided in the store, an electronic payment server that provides electronic payment services via a network, for example.

Next, a functional configuration of the self-POS terminal 1 will be described with reference to FIG. 4. FIG. 4 is a diagram showing an example of the functional configuration of the self-POS terminal 1 according to the first embodiment. As shown in FIG. 4, the self-POS terminal 1 includes, as the functional configuration, an operation reception unit 101, a display control unit 102, and a product sales data processing unit 103.

Part or all of the functional configuration of the self-POS terminal 1 may be a software configuration implemented through cooperation between the processor (e.g., the CPU 11) of the self-POS terminal 1 and the program stored in the memory (e.g., the ROM 12, the storage unit 14). Further, part or all of the functional configuration of the self-POS terminal 1 may be a hardware configuration implemented by a dedicated circuit and the like installed in the self-POS terminal 1.

The operation reception unit 101 receives user operations via the operation unit 82. Specifically, the operation reception unit 101 receives operations on various screens displayed on the display unit 81, and notifies the CPU 11 of the contents of the received operations.

The display control unit 102 controls the display unit 81 to display various screens. For example, the display control unit 102 in cooperation with the product sales data processing unit 103 causes the display unit 81 to display various screens to assist in the purchase of the product. In addition, the display control unit 102 serves as an example of the display unit by cooperating with the product sales data processing unit 103.

The product sales data processing unit 103 is an example of a first acquisition unit, a registration unit, and a second acquisition unit. Furthermore, the product sales data processing unit 103 also serves as an example of the display unit by cooperating with the display control unit 102. The product sales data processing unit 103 executes various processes for assisting in the purchase of the product by cooperating with the hardware and other functional configurations provided in the device. For example, when receiving an operation to start a transaction via the operation unit 82, the product sales data processing unit 103 starts processing the product sales data related to one transaction.

When starting a transaction, the product sales data processing unit 103 enables the reading operation of the code reading unit 5 and waits for the product code to be read. When the product code is read by the code reading unit 5, the product sales data processing unit 103 acquires the read product code and specifies the product corresponding to the product code from the product master 141. Then, the product sales data processing unit 103 executes a registration process in which the product code and product information of the specified product are stored in a storage medium such as the RAM 13 in association with the number of purchased items (quantity) of the product. It is to be noted that the number of purchased items is set to “1” in the initial state. In the following description, information on each product registered in the registration process will also be referred to as “registration data.”

In addition, when the product sales data processing unit 103 receives an operation (hereinafter also referred to as closing operation) to instruct the end of registration or start of checkout via the operation unit 82, the product sales data processing unit 103 ends the registration process and starts the checkout process. Specifically, upon receiving the closing operation, the product sales data processing unit 103 calculates the total amount of products registered up to the closing operation, and executes the checkout process of settling the total amount with the payment amount paid via the cash storing and dispensing unit 4 or the like. During the checkout process, the product sales data processing unit 103 pays out the change from the cash storing and dispensing unit 4, if there is change. Further, the product sales data processing unit 103 causes the printing unit 7 to dispense a receipt on which the product information, the total amount, the payment amount, etc. are printed.

In addition, the product sales data processing unit 103 in cooperation with the display control unit 102 causes the display unit 81 to display a screen (user interface) to assist in the purchase of the product during the product sales data processing described above.

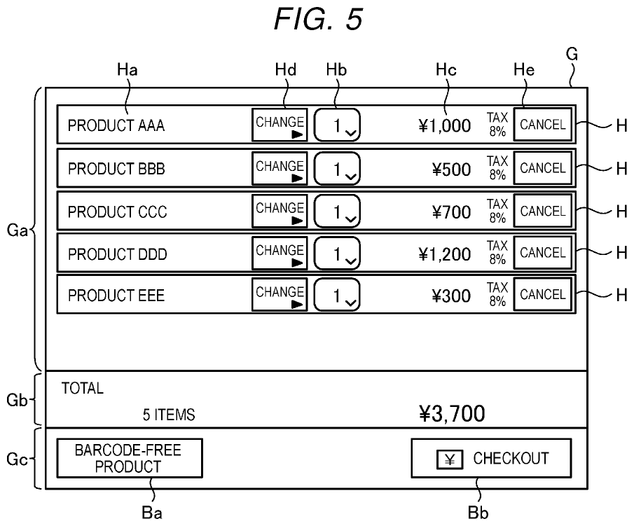

The screens displayed on the display unit 81 by the product sales data processing unit 103 will be described below with reference to FIGS. 5 to 11.

For example, the product sales data processing unit 103 causes the display unit 81 to display a product registration screen G in FIG. 5 as a screen for assisting the registration process. FIG. 5 is a diagram showing an example of a screen displayed on the self-POS terminal 1 of the first embodiment, and shows an example of the product registration screen.

As shown in FIG. 5, the product registration screen G includes a first display area Ga, a second display area Gb, and a third display area Gc.

The first display area Ga is an area for locating information on the products registered by the registration process in the order of registration and displaying a list (hereinafter also referred to as a list display). Specifically, the first display area Ga has a small area H for displaying the products registered in the registration process. A product name Ha, a quantity Hb, an amount Hc, etc. of the registered product are displayed in the small area H. The quantity Hb is the number of purchased products. The amount Hc refers to the amount obtained by multiplying the price (unit price) of the quantity by the quantity. In addition, FIG. 5 shows an example in which five products (product AAA to product EEE) are registered.

Further, a change button Hd and a cancel button He are displayed in the small area H. The change button Hd is an operator for instructing a change in quantity. Specifically, when the product sales data processing unit 103 receives an operation of the change button Hd after the quantity of a product is changed, the product sales data processing unit 103 updates the number of purchased items provided in the registration data of the product that is the target of the operation to the value after the change.

The cancellation button He is an operator for instructing cancellation of the registration. Specifically, when the product sales data processing unit 103 receives the operation of the cancellation button He, the product sales data processing unit 103 cancels the registration by deleting the registration data of the product that is the target of the operation, adding the flag information indicating the cancellation state, etc. In addition, the product sales data processing unit 103 may add a strikethrough line or the like to the product name or the like of the cancelled product to display in the first display area Ga that the product is cancelled.

It is to be noted that FIG. 5 shows an example of locating the registered products from top to bottom in the order of registration, but embodiments are not limited thereto, and the arrangement in the reverse order is possible.

The second display area Gb is an area for displaying the total number and total amount of the registered products. The product sales data processing unit 103 calculates the total number of items by adding up the quantities of the registered products, and displays the calculated total number of items in the second display area Gb. Further, the product sales data processing unit 103 calculates a total amount by adding the amounts of the registered products, and displays the calculated total amount in the second display area Gb. In addition, the product sales data processing unit 103 calculates the total number of items and the total amount each time the registration data are updated by the operation of the change button Hd or the cancel button He every time a new product is registered, and updates the second display area Gb.

The third display area Gc is an area for displaying various operators related to the operation of the self-POS terminal 1. The operator such as a barcode-free product button Ba and a checkout button Bb are displayed in the third display area Gc. In addition, the operator represents a character string or illustration (hereinafter also referred to as an object) for guiding the function of the operator or the process implemented by the operation.

The barcode-free product button Ba is an operator used when registering a product to which no code symbol is attached. When the product sales data processing unit 103 receives the operation of the barcode-free product button Ba, based on the symbol flag of the product master 141, the product sales data processing unit 103 causes the display unit 81 to display a selection screen (not shown) showing each product without a code symbol for selection thereof. For example, the product sales data processing unit 103 may display the selection screen that can narrow down the products to be registered, such as by displaying the category of each product for selection thereof, and when the category is selected, displaying the product names of products belonging to the category for selection thereof. When the product sales data processing unit 103 receives the product selection from the selection screen, the product sales data processing unit 103 performs the registration process for the selected product and displays the registered product in the first display area Ga of the product registration screen G.

The checkout button Bb is an operator for performing the closing operation (this will be also referred to herein as a closing button). When receiving the operation of the checkout button Bb, the product sales data processing unit 103 ends the registration process and starts the checkout process of settling the total amount of the products registered up to the time of the operation. It is to be noted that the product sales data processing unit 103 may make the checkout button Bb inoperable by not displaying or disabling the checkout button Bb, for example, until the first product is registered.

Meanwhile, on the product registration screen G, because the main focus is on clearly indicating the registered products, the display areas of the first display area Ga and the second display area Gb cover most of the screen as shown in FIG. 5. Therefore, the operator such as the checkout button Bb is generally located at an edge of the screen, such as at the bottom of the screen. In addition, on the product registration screen G, since the information regarding the registered product is additionally displayed in the first display area Ga each time registration is performed, the relatively large amount of information is displayed, and the operator's gaze tends to stay in the first display area Ga.

Therefore, on the product registration screen G, there is a problem in that it is difficult for the operator to find the position of the closing button. If the closing button is difficult to find, the customers particularly who are not familiar with operating the POS terminals may not be able to proceed to checkout for the product even after completing registering the products, which may hinder smooth transactions. Additionally, although it is also conceivable to display the checkout button Bb in a large size to increase its noticeability in the product registration screen G, in this case, it is necessary to reduce the size of either or both of the first display area Ga and the second display area Gb. In this way, on the product registration screen G, there is a trade-off relationship between the visibility of information related to the registered products and the distinctiveness of the checkout button Bb, and simply increasing the size of the checkout button Bb may actually reduce the operability of the product registration screen G.

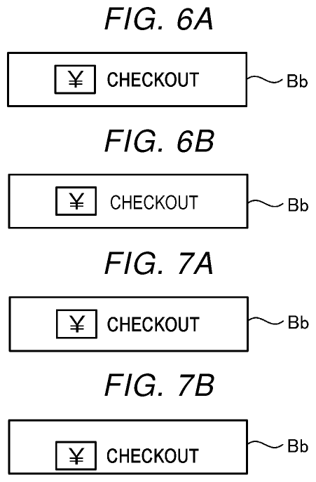

Therefore, the product sales data processing unit 103 of the present embodiment periodically changes the display mode of the checkout button Bb using a moving animation to highlight the checkout button Bb so as to present the position of the checkout button Bb for the notice of the operator. Hereinafter, a method for highlighting the checkout button Bb will be described with reference to FIGS. 6 to 11.

FIG. 6 is a diagram provided to explain a first highlighting method. With the first highlighting method, the checkout button Bb is highlighted by periodically changing the size of the object represented in the checkout button Bb. For example, as shown in FIGS. 6A and 6B, the product sales data processing unit 103 displays the character string represented in the checkout button Bb while switching the character size to a different size. Specifically, the product sales data processing unit 103 highlights the checkout button Bb by periodically displaying the animation from FIG. 6A to FIG. 6B. The cycle of animation display is not particularly limited, and may be at intervals of 1 second, for example. Further, FIG. 6 shows an example in which the character size is changed in two stages, “large” and “small”, but the number of stages in which the character size is changed is not limited thereto.

FIG. 7 is a diagram provided to explain a second highlighting method. With the second highlighting method, the checkout button Bb is highlighted by periodically changing the arrangement position of the object represented within the checkout button Bb. For example, as shown in FIGS. 7A and 7B, the product sales data processing unit 103 switches and arranges the object represented in the checkout button Bb in different positions in the vertical direction such that the object is displayed while moving vertically.

Specifically, the product sales data processing unit 103 highlights the checkout button Bb by periodically displaying the animation from FIG. 7A to FIG. 7B. The cycle of animation display is not particularly limited, and may be at intervals of 1 second, for example.

Further, FIG. 7 shows an example in which the object is moved in the vertical direction to represent a press operation of the checkout button Bb. In this way, the product sales data processing unit 103 presents how to operate the checkout button Bb in the process of highlighting the same. As a result, by the vertically moving object such as the character in the checkout button Bb, a customer who is an operator easily and intuitively recognizes the need to press the checkout button Bb as a next step. Therefore, the product sales data processing unit 103 can prompt the operator to operate the checkout button Bb. It is to be noted that the moving direction of the object within the checkout button Bb is not limited to the vertical direction, but may be moved in the horizontal direction, for example.

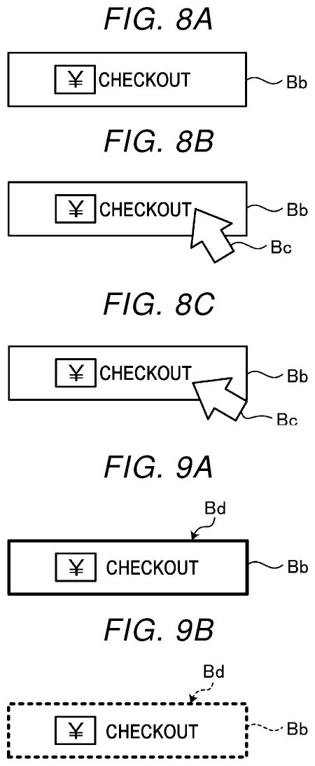

FIG. 8 is a diagram provided to explain a third highlighting method. With the third highlighting method, the checkout button Bb is highlighted by periodically performing a display process of superimposing another object on the checkout button Bb. It is preferable to use, as the another object, an illustration or an icon (hereinafter also referred to as a cursor figure) such as an arrow or fingertip pointing to the checkout button Bb. For example, the product sales data processing unit 103 moves another object Bc over the checkout button Bb to highlight the checkout button Bb, as shown in FIGS. 8A and 8B. Specifically, the product sales data processing unit 103 highlights the checkout button Bb by periodically displaying the animation from FIG. 8A to FIG. 8B.

Further, the product sales data processing unit 103 may use the another object Bc to provide guidance on how to operate the checkout button Bb. For example, as shown in FIGS. 8B and 8C, the product sales data processing unit 103 switches the arrangement angle of the another object Bc superimposed on the checkout button Bb in the vertical direction, thereby displaying the another object Bc pressing the checkout button Bb. In this case, the product sales data processing unit 103 may periodically display the animation of FIG. 8A-FIG. 8B-FIG. 8C-FIG. 8B to highlight the checkout button Bb. In this way, the product sales data processing unit 103 can present how to operate the checkout button Bb in the process of highlighting the same, thereby prompting the user to operate the checkout button Bb. It is to be noted that the cycle of animation display is not particularly limited, and may be at intervals of 2 seconds, for example.

FIG. 9 is a diagram provided to explain a fourth highlighting method. With the fourth highlighting method, the checkout button Bb is highlighted by periodically changing the display color of the outline of the checkout button Bb. For example, the product sales data processing unit 103 displays an outline Bd of the checkout button Bb while switching the display color, as shown in FIGS. 9A and 9B. Specifically, the product sales data processing unit 103 highlights the checkout button Bb by periodically displaying the animation from FIG. 9A to FIG. 9B. It is to be noted that in FIG. 9, the differences in the display colors are represented by the differences in line types. For example, the outline Bd displayed in orange in FIG. 9A is displayed in green in FIG. 9B. It is to be noted that the cycle of animation display is not particularly limited, and may be at intervals of 1 second, for example. Further, while FIG. 9 shows two display colors that are switchable, embodiments are not limited thereto, and three or more display colors may be switched.

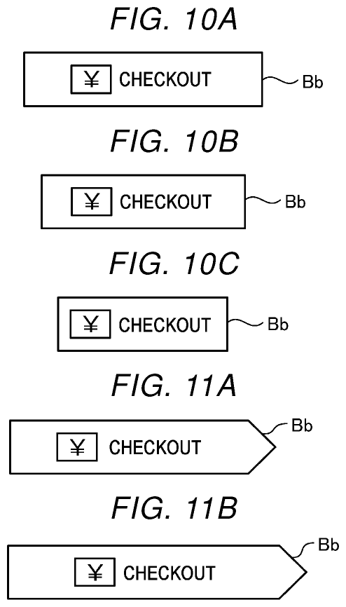

FIG. 10 is a diagram provided to explain a fifth highlighting method. With the fifth highlighting method, the checkout button Bb is highlighted by periodically changing the size of the checkout button Bb. For example, the product sales data processing unit 103 displays the checkout button Bb while expanding and contracting the long sides thereof, as shown in FIGS. 10A, 10B, and 10C. As an example, the product sales data processing unit 103 highlights the checkout button Bb by periodically displaying the animation of FIG. 10A-FIG. 10B-FIG. 10C-FIG. 10B-FIG. 10A. It is to be noted that the cycle of animation display is not particularly limited, and may be at intervals of 1 second, for example. Further, while FIG. 10 shows the long sides of the checkout button Bb are expanded and contracted, embodiments are not limited thereto, and for example, the short sides of the checkout button Bb may be expanded and contracted.

FIG. 11 is a diagram provided to explain a sixth highlighting method. With the sixth highlighting method, the checkout button Bb is highlighted by changing the shape of the checkout button Bb. For example, as shown in FIGS. 11A and 11B, the product sales data processing unit 103 displays the checkout button Bb with a pointed right end, while expanding and contracting the checkout button Bb to the right. Specifically, the product sales data processing unit 103 highlights the checkout button Bb by periodically displaying the animation from FIG. 11A to FIG. 11B. It is to be noted that the cycle of animation display is not particularly limited, and may be at intervals of 1 second, for example. The product sales data processing unit 103 uses any one of the six highlighting methods described above or a combination of a plurality of highlighting methods to highlight and display the position of the checkout button Bb. As a result, the product sales data processing unit 103 can periodically change the display mode of the checkout button Bb using a moving animation so as to effectively highlight and display the position of the checkout button Bb in the product registration screen G. Therefore, the operator of the self-POS terminal 1 can easily confirm the position within the product registration screen G, at which the checkout button Bb is placed.

It is to be noted that the highlighting method is not limited to the examples described above. For example, the background color of the checkout button Bb may be changed periodically in accordance with the animation display of the six highlighting methods.

Further, the product sales data processing unit 103 may highlight the checkout button Bb while displaying the product registration screen G, or may start highlighting the checkout button Bb when a predetermined condition (hereinafter also referred to as highlighting condition) is satisfied. In the latter case, it is preferable that the product sales data processing unit 103 starts highlighting the checkout button Bb at the timing when the closing operation is expected to be performed, based on the status of the operator or the registration status of the product.

For example, the product sales data processing unit 103 in cooperation with the code reading unit 5 and the operation unit 82 acquires, as the state information indicating the status of the operator or the registration status of the product, information indicating whether or not the self-POS terminal 1 is being operated. Then, the product sales data processing unit 103 starts highlighting the checkout button Bb when no-operation state continues for a predetermined period of time (e.g., for 10 seconds, etc.). For example, by the no-operation state, it means not only a state in which no product is being read, but also a state in which no operation is performed on the product registration screen G. In addition, the no-operation state may simply refer to the state in which no product is being read. In this case, it is conceivable that although the customer completed the product registration operation, the customer may not be able to recognize that the operator to be operated in order to proceed to the next process is the checkout button Bb, and is operating any other location on the product registration screen G.

That is, the product sales data processing unit 103 may start highlighting the checkout button Bb when all the products to be registered are read. Accordingly, the product sales data processing unit 103 can start highlighting the checkout button Bb at the timing when the closing operation is expected to be performed, thereby efficiently assisting in the operation of the checkout button Bb.

In addition, when the operator's operation such as reading of a new product is received after starting highlighting the checkout button Bb, the product sales data processing unit 103 may change the checkout button Bb to a non-highlighted state, that is, to a normal display state (hereinafter also referred to as normal display) by canceling the highlighted display.

Further, for example, the product sales data processing unit 103 may acquire the weight measured by the weight sensor 92 as the state information indicating the status of the operator or the registration status of the product. In this case, after starting the product registration process, the product sales data processing unit 103 starts highlighting the checkout button Bb when the weight measured by the weight sensor 92 is equal to or less than a threshold value. The threshold value for the weight is preferably set based on the weight of a shopping cart used in the store, and for example, the weight of the cart may be set as the threshold value.

In this case, the product sales data processing unit 103 may start highlighting the checkout button Bb when there are no more products left in the basket, that is, when all the products placed in the basket are read. Accordingly, the product sales data processing unit 103 can start highlighting the checkout button Bb at the timing when the closing operation is expected to be performed, thereby efficiently assisting in the operation of the checkout button Bb.

When receiving the operation of the checkout button Bb, the product sales data processing unit 103 causes the display unit 81 to display a screen (not shown) on which a payment method such as cash payment, electronic money payment, or credit card payment can be selected. Then, when the operator selects the payment method, the product sales data processing unit 103 performs the checkout process using the selected payment method.

For example, when the cash payment is selected, the product sales data processing unit 103 receives cash payment via the cash storing and dispensing unit 4, and executes the checkout process of settling the total amount of the products with the received amount. Further, for example, when electronic money payment or credit card payment is selected, input of payment information related to the payment is received via the code reading unit 5 or the card reading unit 6. The product sales data processing unit 103 in cooperation with an external payment server and the like executes the payment process of settling the total amount of the products registered for sale based on the input payment information. Such payment information may be a credit card number or a two-dimensional code for code payment, for example.

In this self-POS terminal 1, the customer who is the operator takes out a product from a basket placed on the first placing table 91 and performs the product registration operation to cause the code reading unit 5 to read a code symbol attached to the product. Then, the customer performs a bagging operation of putting the read product into a shopping bag or the like placed on the second placing table 93. The self-POS terminal 1 executes the registration process for the product for which the product registration operation was performed. After performing the product registration operation for all products, the customer operates the closing button such as the checkout button Bb to start the checkout for the registered products. The self-POS terminal 1 executes the checkout process on the condition that the closing operation was performed.

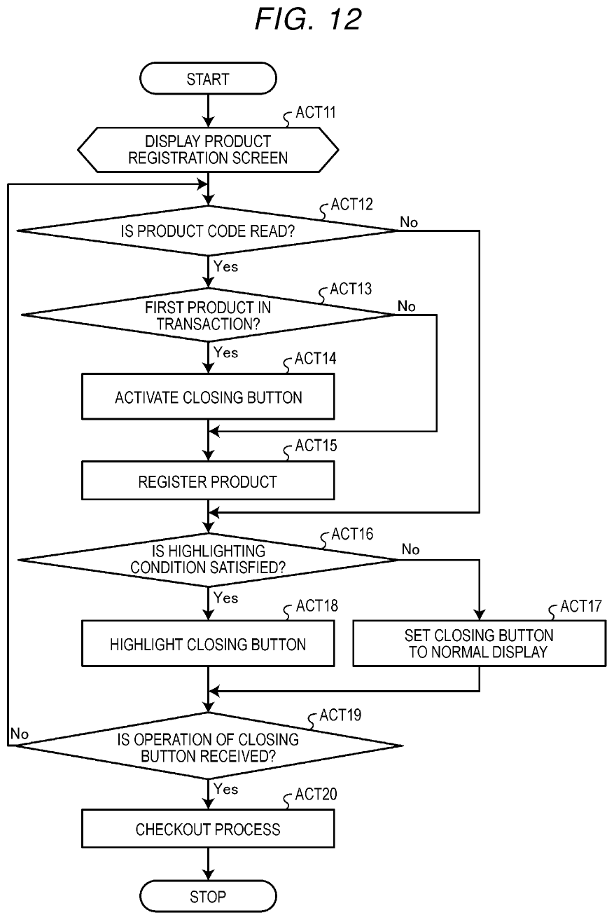

Next, an example of product sales data processing performed by the self-POS terminal 1 will be described. FIG. 12 is a flowchart showing an example of the product sales data processing performed by the self-POS terminal 1 of the first embodiment. As a premise of this processing, it is assumed that the product registration screen G is displayed on the display unit 81 (ACT 11).

First, the product sales data processing unit 103 determines whether the code reading unit 5 reads the product code (ACT 12). When the product code is not read (ACT 12; No), the product sales data processing unit 103 proceeds to ACT 16.

When the product code is read by the code reading unit 5 (ACT 12; Yes), the product sales data processing unit 103 determines whether the product is the first product read in this transaction (ACT 13). By the transaction, it means a period from when the customer operating the self-POS terminal starts the product registration operation to when the customer performs the closing operation, or to when the customer performs the checkout, for example.

If the product is the first product read in this transaction (ACT 13; Yes), the product sales data processing unit 103 activates the closing button such as the checkout button Bb to be operable (ACT 14), and proceeds to ACT 15. For example, the product sales data processing unit 103 sets the closing button to the normal display on the product registration screen G, thereby making the closing button operable. It is to be noted that if the product is not the first product read in this transaction (ACT 13; No), the process proceeds to ACT 15.

Next, based on the product code read in ACT 12, the product sales data processing unit 103 executes the registration process for the product corresponding to the product code (ACT 15). Next, the product sales data processing unit 103 determines whether or not the status of the operator or the registration status of the product satisfies the highlighting condition for highlighting the closing button (ACT 16).

For example, the product sales data processing unit 103 determines that the highlighting condition is satisfied when the no-operation state continues for a predetermined period of time. Specifically, the product sales data processing unit 103 determines that the highlighting condition is satisfied when a loop process of ACT 12; No-ACT 16; No-ACT 17-ACT 19; No is executed for a predetermined period of time. Further, for example, the product sales data processing unit 103 determines that the highlighting condition is satisfied when the weight measured by the weight sensor 92 is equal to or less than the threshold value.

When determining that the highlighting condition is not satisfied (ACT 16; No), the product sales data processing unit 103 sets the closing button to the normal display (ACT 17), and proceeds to ACT 19. When determining that the highlighting condition is satisfied (ACT 16; Yes), the product sales data processing unit 103 highlights the closing button using any of the highlighting methods described above (ACT 18), and proceeds to ACT 19.

Then, the product sales data processing unit 103 determines whether or not the operation of the closing button is received (ACT 19). When the product sales data processing unit 103 does not receive the operation of the closing button (ACT 19; No), the process returns to ACT 12. On the other hand, when receiving the operation of the closing button (ACT 19; Yes), the product sales data processing unit 103 executes the checkout process (ACT 20) and ends the process.

As described above, the self-POS terminal 1 of the present embodiment acquires, via the code reading unit 5, the product code that can specify the product, and performs the product registration process based on the acquired product code. In addition, the self-POS terminal 1 causes the display unit 81 to display the product registration screen G displaying the information on the registered products arranged in the order of registration, and the closing button. Furthermore, the self-POS terminal 1 periodically changes the display mode of the closing button using a moving animation to highlight the closing button on the product registration screen G.

As a result, the self-POS terminal 1 can effectively display the position of the closing button on the product registration screen G that focuses on displaying the information on the registered product, thereby ensuring that the operator recognizes the position of the closing button. Therefore, the self-POS terminal 1 can improve the operability of the product registration screen G.

### Second Embodiment

In the first embodiment described above, a mode has been described in which it is determined whether or not the highlighting condition is satisfied based on the duration of the no-operation state or the measurement result of the weight sensor 92. However, the criteria for determining the highlighting condition are not limited thereto. Therefore, in the second embodiment, a mode will be described in which the highlighting condition is determined using state information different from that in the first embodiment to control the timing to start highlighting. It is to be noted that differences from the embodiment described above will be mainly described, and detailed description of the elements or operations overlapping with those already described will be omitted.

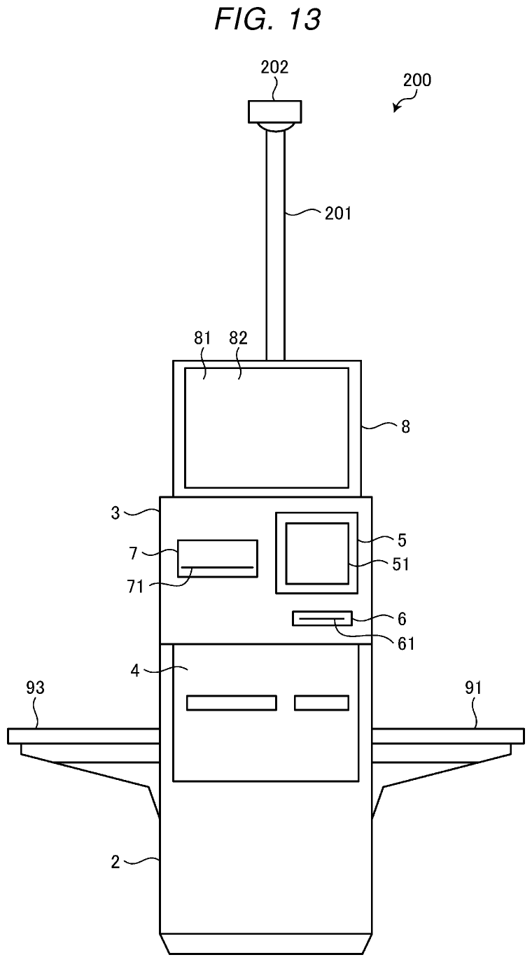

FIG. 13 is a front view showing an example of an external appearance of a self-POS terminal 200 according to the second embodiment. The self-POS terminal 200 is an example of the product sales data processing device, and corresponds to the self-POS terminal 1. The self-POS terminal 200 has the same configuration as the self-POS terminal 1.

In addition, the self-POS terminal 200 includes a columnar pole 201 extending upward from the top surface of the first housing 2 on a rear side of the first housing 2. An imaging unit 202 is attached to an upper end of the pole 201. The imaging unit 202 is an imaging device such as a digital camera, and the imaging direction is directed downward.

The imaging unit 202 is provided at a position where the imaging unit 202 can image the operator (customer) operating the self-POS terminal 1, and images the operator operating the self-POS terminal 1 from above. It is to be noted that imaging refers to continuously capturing moving images or capturing continuously still images at predetermined time intervals (e.g., every 1 second). Further, the position where the imaging unit 202 is provided is not limited to the example shown in FIG. 13 as long as it is possible to image the operator operating the self-POS terminal 1 in that position.

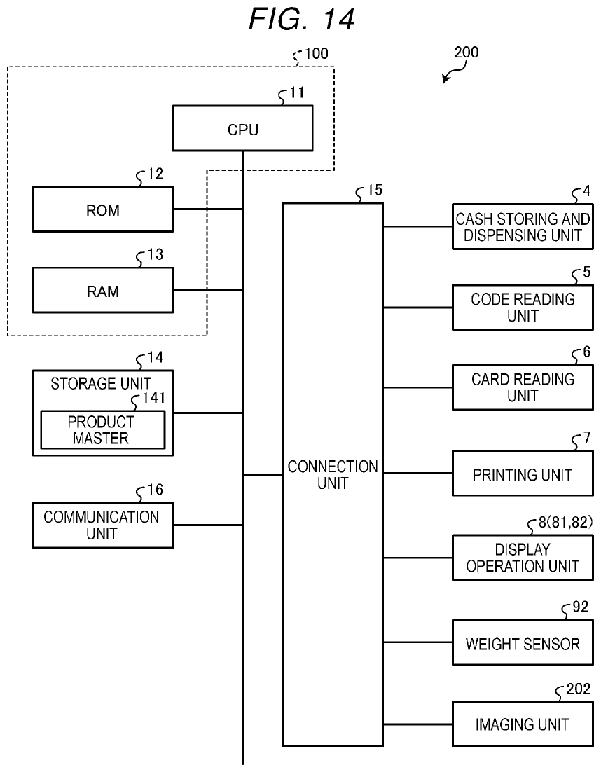

FIG. 14 is a diagram showing an example of a hardware configuration of the self-POS terminal 200 according to the second embodiment. As shown in FIG. 14, the self-POS terminal 200 has the same configuration as the self-POS terminal 1. Further, the imaging unit 202 described above is connected to the connection unit 15 of the self-POS terminal 200. In other words, the control unit 100 can acquire the image captured by the imaging unit 202.

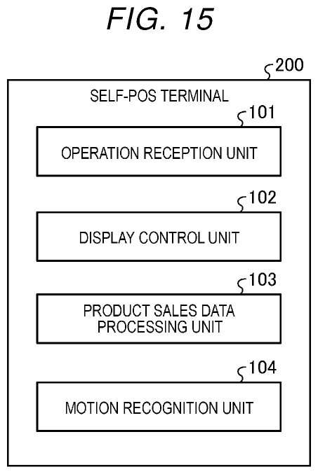

FIG. 15 is a diagram showing an example of a functional configuration of the self-POS terminal 200 according to the second embodiment. As shown in FIG. 15, the self-POS terminal 200 has the same functional configuration as the self-POS terminal 1. Further, the self-POS terminal 200 includes a motion recognition unit 104 as a new functional configuration.

The motion recognition unit 104 is an example of the second acquisition unit. Based on the image captured by the imaging unit 202, the motion recognition unit 104 acquires (or recognizes) the state information representing the operational state and psychological state of the operator operating the self-POS terminal 200 from the image.

For example, the motion recognition unit 104 recognizes whether the operator of the self-POS terminal 200 is performing the product registration operation or the operation on the display operation unit 8. Further, the motion recognition unit 104 recognizes whether the operator of the self-POS terminal 200 is in a state of hesitation in operation.

The method for recognizing the operational state and the psychological state of the operator is not particularly limited, and any known technique may be used. For example, the motion recognition unit 104 may be configured to recognize motions performed by the operator using a model trained by machine learning the movements of a body (or skeleton), hand movements, etc. when operating the self-POS terminal 200. Further, for example, the motion recognition unit 104 may be configured to recognize the psychological state of the operator by using a model trained to estimate the psychological state from the operator's facial expressions shown in the facial image and body movements (e.g., behavior).

Furthermore, the product sales data processing unit 103 of the present embodiment determines whether or not the condition for highlighting the closing button is satisfied based on the recognition result of the motion recognition unit 104. For example, the product sales data processing unit 103 determines that the condition for highlighting the closing button is satisfied when the state in which the operator of the self-POS terminal 200 does not perform the product registration operation or does not perform the operation on the display operation unit 8 continues for a predetermined period of time. Further, for example, the product sales data processing unit 103 determines that the condition for highlighting the closing button is satisfied when it is recognized that the operator of the self-POS terminal 200 is in a state of hesitation in operation. Then, when determining that the highlighting condition is satisfied, the product sales data processing unit 103 highlights the closing button using any of the highlighting methods described above.

In this case, the product sales data processing unit 103 can start highlighting the checkout button Bb when all the products to be registered are read or when the user is searching for the checkout button Bb. Accordingly, the product sales data processing unit 103 can start highlighting the checkout button Bb at the timing when the closing operation is expected to be performed, thereby efficiently assisting in the operation of the checkout button Bb.

In addition, the product sales data processing unit 103 may determine the highlighting condition based on the state information derived from the motion recognition unit 104 described above in combination with the highlighting condition described in the first embodiment. For example, when the weight measured by the weight sensor 92 is equal to or less than the threshold value and the motion recognition unit 104 recognizes that the user is in a state of hesitation in operation, it may be determined that the condition for highlighting the closing button is satisfied.

Because the product sales data processing performed by the self-POS terminal 200 corresponds to the flowchart described with reference to FIG. 12, description thereof will be omitted.

It should be noted that each of the embodiments described above can be appropriately modified and implemented by changing a part of the configurations or functions of each of the devices described above. Therefore, hereinbelow, certain modifications of each of the embodiments described above will be described as another embodiments. In the following description, differences from the embodiment described above will be mainly described, and detailed description of the elements or operations overlapping with those already described will be omitted. Further, the modifications described below may be implemented individually or in combination as appropriate.

### First Modification

In the embodiment described above, an example has been described in which the product registration screen G displayed on the display unit 81 is displayed on a horizontal screen, but embodiments are not limited thereto, and it may be displayed on a vertical screen.

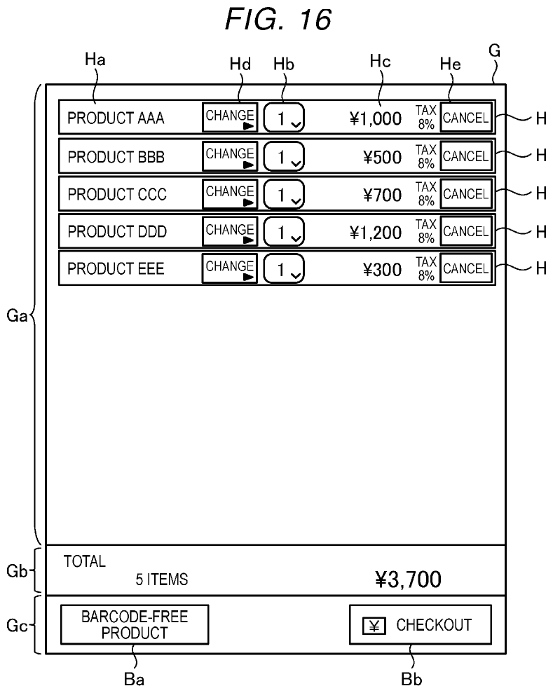

FIG. 16 is a diagram showing an example of a display format of the product registration screen G according to a first modification, and shows an example in which the product registration screen G of FIG. 5 is displayed on a portrait screen. As shown in FIG. 16, the contents (display contents, screen configuration) displayed on the product registration screen G are the same even when it is displayed in a portrait orientation.

In addition, in the case of a configuration in which the registered products are displayed in a list from the top of the first display area Ga, the product name, etc. of the registered products will be displayed at the top of the screen as shown in FIG. 16. In this case, the gaze of the customer, who is the operator, tends to stay in an upper part of the screen where the registered products are displayed. Therefore, compared to a landscape screen, it may be difficult for the operator to notice the presence of the closing button such as the checkout button Bb positioned at a lower part of the screen.

In the self-POS terminal 1 (or the self-POS terminal 200) according to this modification, even when the product registration screen G is displayed as the portrait screen, the closing button can be effectively highlighted as in the embodiment described above. As a result, the self-POS terminal 1 (or the self-POS terminal 200) can appeal the presence of the closing button positioned at the lower part of the screen on the portrait screen where the operator's gaze tends to be concentrated at the top of the screen, thereby efficiently assisting the operator on the operation.

In addition, the product sales data processing unit 103 may be configured to switch the method of highlighting the closing button in accordance with whether the product registration screen G is displayed as a landscape screen or a portrait screen. In this case, as described above, when the product registration screen G is the portrait screen, the area where the operator's gaze is concentrated and the position of the closing button may be at a longer distance from each other. Therefore, when the product registration screen G is displayed as the portrait screen, it is preferable that the product sales data processing unit 103 uses a highlighting method that provides a higher degree of highlighting than when the product registration screen G is displayed as the landscape screen. For example, when the product registration screen G is displayed as the portrait screen, the product sales data processing unit 103 may use the third and fourth highlighting methods together to perform highlighting.

### Second Modification

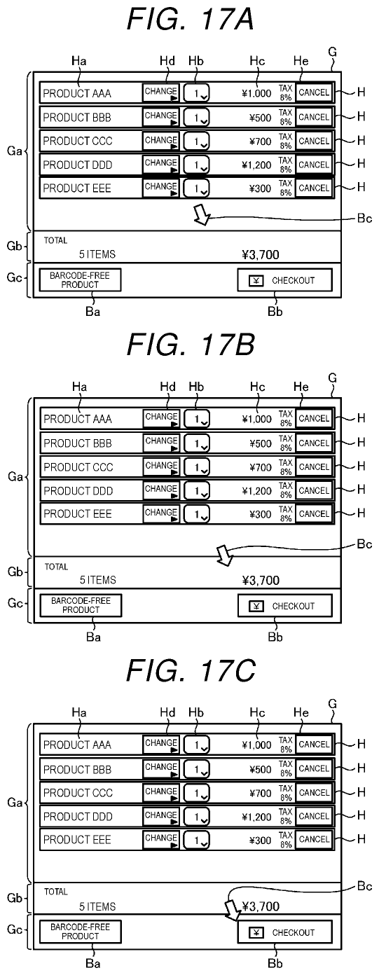

In the embodiment described above, as an example of the highlighting method for the checkout button Bb, the highlighting method (third highlighting method) for moving another object Bc displayed around the checkout button Bb onto the checkout button Bb has been described (see FIG. 8). With the third highlighting method, a position used as a base point of display of the another object Bc is not limited to the above example. Therefore, in the present modification, a modification of the third highlighting method will be described with reference to FIG. 17.

FIG. 17 is a diagram provided to explain a modification of the third highlighting method. With this modification, likewise the third highlighting method described above, the display process of moving another objects Bc onto the checkout button Bb is performed periodically, but the position used as the base point for initially displaying the another object Bc is different.

Specifically, as shown in FIG. 17A, the base point of the another object Bc is placed within the first display area Ga. The position used as the base point within the first display area Ga may be set freely.

For example, the base point may be set in an empty space (an area where the small area H is not displayed) within the first display area Ga. Further, for example, the base point may be set in the vicinity of any of the small areas H displayed in the first display area Ga, which is placed at the lowest part. Further, for example, the base point may be set in the vicinity of any of the small areas H displayed in the first display area Ga, which displays the most recently registered product. In addition, in the present embodiment, since the registered products are arranged downward in the order of registration, the small area H placed at the lowest part corresponds to the small area H for displaying the most recently registered product.

Furthermore, when displaying the another object Bc in the first display area Ga, the product sales data processing unit 103 according to the present modification moves the another object Bc to the checkout button Bb, as shown in FIG. 17B-FIG. 17C. Then, the product sales data processing unit 103 highlights the checkout button Bb by periodically displaying the animation of FIG. 17A-FIG. 17B-FIG. 17C.

Accordingly, the self-POS terminal 1 according to the present modification can ensure that the operator recognizes the position of the checkout button Bb on the product registration screen G, as in the embodiment described above.

Furthermore, since the self-POS terminal 1 according to the present modification moves the another object Bc displayed within the first display area Ga to the checkout button Bb, it is possible to guide the operator's gaze from the first display area Ga where the operator's gaze tends to be concentrated, to the checkout button Bb. In particular, when moving the another object Bc from the vicinity of the small area H that displays the most recently registered product to the checkout button Bb, there is a high possibility that the operator's gaze is directed to the small area H, so that it is possible to more efficiently guide the gaze to the checkout button Bb. Therefore, the self-POS terminal 1 according to the present modification allows the operator to efficiently recognize the position of the checkout button Bb.

### Third Modification

In the embodiment described above, the mode has been described in which the self-POS terminal 1 (the self-POS terminal 200) performs the checkout process in response to the operation of the closing button, but embodiments are not limited thereto, and a mode may be adopted in which the checkout process is performed by another device.

In this case, the product sales data processing unit 103 of the self-POS terminal 1 (the self-POS terminal 200) generates information that can specify the registered products and number thereof, that is, transaction information that can specify the total amount of the registered products in response to the operation of the closing button. Then, the product sales data processing unit 103 outputs the generated transaction information via a network or a print medium to deliver the same to a checkout device that performs the checkout process.

In the former case, for example, the product sales data processing unit 103 may directly transmit the transaction information to the checkout device serving as the checkout destination, or may transmit the transaction information indirectly via a store server or the like. In the latter case, for example, the product sales data processing unit 103 may be in the form of a printout with the transaction information coded in a code symbol.

Further, the product sales data processing unit 103 may also be in the form of storing registration data on a server device such as a store server. In this case, the product sales data processing unit 103 may output, as the transaction information, information for reading the registration data stored in the server device. For example, if registration data is stored in association with a unique ID that allows transactions to be specified, the product sales data processing unit 103 may output the ID as the transaction information.

In this way, the store configuration to which the product sales data processing device can be applied to various store configurations without being particularly limited. The program executed by the product sales data processing device of each of the embodiments (modifications) described above is provided in a state of being installed in advance in a ROM, a storage unit, or the like. The program executed by the product sales data processing device of each of the embodiments described above may be configured to be provided as a file in an installable format or an executable format recorded on a computer-readable recording medium such as a CD-ROM, a flexible disk (FD), a CD-R, or a Digital Versatile Disk (DVD).

Further, the program executed by the product sales data processing device of each of the embodiments described above may be stored on a computer connected to a network such as the Internet and provided by being downloaded via the network. Further, the program executed by the product sales data processing device of each of the embodiments described above may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product sales data processing device, comprising:
a first acquisition component for acquiring identification information that specifies a product;
a registration component for registering the product based on the identification information; and
a display for arranging and displaying, on a screen, information on products registered by the registration component in the order of registration, and displaying an operator for instructing an end of registration,
wherein the display periodically changes a display mode of the operator using a moving animation so as to perform highlighting.

2. The product sales data processing device according to claim 1, wherein the display periodically changes a position or size of an object displayed inside the operator so as to perform highlighting.

3. The product sales data processing device according to claim 1, wherein the display periodically performs a display process of superimposing another object on the operator so as to perform highlighting.

4. The product sales data processing device according to claim 1, wherein the display periodically changes a display color of an outline of the operator so as to perform highlighting.

5. The product sales data processing device according to claim 1, wherein the display periodically changes a size or a shape of the operator so as to perform highlighting.

6. The product sales data processing device according to claim 1, further comprising a second acquisition component for acquiring state information indicating a status of an operator operating the device or a registration status of the product,
wherein the display starts highlighting the operator based on the state information.

7. The product sales data processing device according to claim 6, wherein the second acquisition component acquires, as the state information, information indicating whether or not an operation is being performed on the device, and
the display starts highlighting the operator when a no-operation state continues for a predetermined period of time.

8. The product sales data processing device according to claim 6, wherein the second acquisition component acquires, as the state information, a weight measurement result from a weight sensor installed on a placing component on which a product to be registered is placed, and
the display starts highlighting the operator when the measured weight is equal to or less than a threshold value.

9. The product sales data processing device according to claim 6, wherein the second acquisition component acquires the state information representing an operational state or psychological state of the operator from an image of the operator obtained by capturing images of the operator, and
the display starts highlighting the operator when the operational state or psychological state of the operator satisfies a predetermined condition.

10. A product sales data processing method, comprising:
acquiring identification information that specifies a product;
registering the product based on the identification information; and
arranging and displaying, on a display screen, information on products registered by the registering in the order of registration, and displaying an operator for instructing an end of registration,
wherein the displaying comprises periodically changing a display mode of the operator using a moving animation so as to perform highlighting.

11. The product sales data processing method according to claim 10, further comprising:
periodically changing on the display screen a position or size of an object displayed inside the operator so as to perform highlighting.

12. The product sales data processing method according to claim 10, further comprising:
periodically performing on the display screen a display process of superimposing another object on the operator so as to perform highlighting.

13. The product sales data processing method according to claim 10, further comprising:
periodically changing on the display screen a display color of an outline of the operator so as to perform highlighting.

14. The product sales data processing method according to claim 10, further comprising:
periodically changing on the display screen a size or a shape of the operator so as to perform highlighting.

15. The product sales data processing method according to claim 10, further comprising:
acquiring state information indicating a status of an operator operating the device or a registration status of the product; and
highlighting the operator based on the state information.

16. The product sales data processing method according to claim 15, further comprising:
acquiring, as the state information, information indicating whether or not an operation is being performed on the device; and
highlighting the operator when a no-operation state continues for a predetermined period of time.

17. The product sales data processing method according to claim 15, further comprising:
acquiring, as the state information, a weight measurement result from a weight sensor installed on a placing component on which a product to be registered is placed; and
highlighting the operator when the measured weight is equal to or less than a threshold value.

18. The product sales data processing method according to claim 15, further comprising:
acquiring the state information representing an operational state or psychological state of the operator from an image of the operator obtained by capturing images of the operator; and
highlighting the operator when the operational state or psychological state of the operator satisfies a predetermined condition.

19. A product sales data processing display device, comprising:
a display for arranging and displaying, on a screen, information on products registered by a registration component for registering a product based on the identification information that specifies the product acquired by an acquisition component in the order of registration, and displaying an operator for instructing an end of registration,
wherein the display periodically changes a display mode of the operator using a moving animation so as to perform highlighting.

20. The product sales data processing display device according to claim 19, wherein the display at least one of:
periodically changes a position or size of an object displayed inside the operator so as to perform highlighting;
periodically performs a display process of superimposing another object on the operator so as to perform highlighting; and
periodically changes a display color of an outline of the operator so as to perform highlighting.
